(19) United States
(12) Patent Application Publication
(10) Pub. No.: US 2023/0405515 A1
(43) Pub. Date: Dec. 21, 2023

(54) METHOD OF CAPTURING CARBON DIOXIDE

(71) Applicant: EVONIK OPERATIONS GMBH, Essen (DE)

(72) Inventor: Thomas HAAS, Münster (DE)

(73) Assignee: EVONIK OPERATIONS GMBH, Essen (DE)

(21) Appl. No.: 18/038,068

(22) PCT Filed: Nov. 19, 2021
(86) PCT No.: PCT/EP2021/082303

§ 371 Date: May 22, 2023

(30) Foreign Application Priority Data
Dec. 3, 2020 (EP) 20211422.9

(51) Int. Cl. B01D 53/14; B01D 53/18

(52) U.S. Cl. CPC B01D 53/1425; B01D 53/1475; B01D 53/1493; B01D 53/18; B01D 2252/103; B01D 2256/22; B01D 2258/06; B01D 2252/20484

(57) ABSTRACT

The present invention relates to a method of extracting carbon dioxide (CO₂) gas from an aqueous solution comprising dissolved CO₂, the method comprising:
(a) contacting the aqueous solution with dissolved CO₂ with an organic phase;
(b) heating the aqueous solution and the organic phase to a temperature of at least 50° C., whereby the CO₂ migrates from the aqueous solution to the organic phase; and
(c) separating the CO₂ from the organic phase,
wherein the aqueous solution comprises at least 50% water by weight at a temperature of 10° C. to and a base; the organic phase has a higher CO₂ solubility relative to water solubility; and the aqueous solution and the organic phase are in direct contact with each other and are maintained as two separate phases.

### FIELD OF THE PRESENT INVENTION

The present invention relates to a method of capturing carbon dioxide (CO₂) from a gas mixture comprising CO₂, in particular ambient air, and enriching the carbon dioxide into a high purity gas stream with decreased water content. In particular, the method uses the varying solubility of carbon dioxide at different temperatures in water and an extractant to extract the CO₂. The present invention also concerns the use of the CO₂ for the production of organic acids and/or alcohols.

### BACKGROUND OF THE INVENTION

Carbon dioxide (CO₂) is a greenhouse gas that is collecting in the atmosphere and causing global warming problems and unwanted climate changes. Most industrial processes that are being carried out internationally release inadvertently small amounts of CO₂ in their exhaust fumes. This CO₂ is being accumulated in the environment and causing an increase in temperature that is leading to uncontrollable climate changes such as melting of the polar ice caps, increase in sea-level globally, floods and the like.

There is thus a need to stabilize atmospheric CO₂ to reduce these problems. One way to do so would be to reduce emissions by increasing the efficiency of combustion processes, as in fossil fuel-based power plants or motor vehicles with internal combustion engines. However, this is an arduous task taking into the account the increase in the number of cars in the world and the increase in the emissions from burning fossil fuels. Another way is to substitute fossil fuels in carbon-based processes with renewable energy or low-carbon fuels. However, this would reduce emissions but increase fuel costs.

Another method is to remove CO₂ from gases containing CO₂ before they are released into the environment. CO₂ scrubbing using aqueous solutions such as aqueous amines is an example of a method that is used to absorb CO₂ from CO₂ containing gases. In these known processes, once the CO₂ is absorbed in the water, to desorb the CO₂, desorption of water is needed as water is present in the aqueous solutions. This step of desorbing water adds costs and reduces the efficiency of the process of absorption of CO₂.

There is also a need in the art to direct capture CO₂ from the atmosphere and to reduce and stabilize the amount of CO₂ in ambient air at 350 to 440 parts per million by volume (ppm). There is also a need to store this captured CO₂ in a form where it may be used as an alternative to fossil fuels in view of the depleting amount of fossil fuels available on earth. There are currently numerous technologies and materials for capturing CO₂ from ambient air discussed in the literature using absorption/adsorption processes with inorganic chemisorbents, amines/imines, zeolites, anionic exchange resins and the like. Processes applied for carbon capture and storage cannot be directly transferred to CO₂ separation from the air due to the humidity of the air, very low CO₂ concentrations and the necessity to process close to ambient temperature and pressure conditions (Goeppert A., (2012), Energy Environ Sci., 5: 7833). Further, in Krekel, D., (2018), Applied Energy, 218:361-381 it has been concluded that the results reported show that CO₂ separation from ambient air will not be able to play a vital role in the abatement of the climate change problem until 2050 due to its strong technological and economic drawbacks.

In Sanz-Perez E., (2016) Chem. Rev., 116: 11840-11876, a historical review of different Direct Air Capture (DAC) techniques are disclosed. In particular, different chemical sorbents that are cycled through sorption and desorption cycles for CO₂ removal from ultra-dilute gases such as air are disclosed in this paper. However, these methods disclosed are not competitive especially since desorbing of CO₂ costs a lot of energy and money.

Another known method of capturing CO₂ from ambient air is to use energy efficient low temperature desorption methods (Vacuum Swing Adsorption/Desorption Cycle). This is at least disclosed in Wurzbacher, J. A., Environ. Sci. Technol. 2012, 46, 9191-9198. However, in parallel to CO₂, water is also adsorbed and therefore needs to be desorbed. Water desorption requires additional energy, which causes an overall energy demand depending on the air humidity. Also, in Wiser, N., Chemical Engineering Science, 2017, 157:221-231, it is mentioned that desorption of CO₂ from aqueous solutions involves high energy consumption and also high costs. This makes the process overall inefficient. There is thus still a need in the art for directly capturing CO₂ from ambient air without using desorbing of CO₂ or water.

More in particular, there is a need in the art to not only directly capture CO₂ from ambient air but also to store the CO₂ so that the stored CO₂ may be used as an alternative source for higher chemicals.

### DETAILED DESCRIPTION OF THE INVENTION

The present invention attempts to solve the problems above by providing a means of extracting CO₂ from an aqueous solution comprising dissolved CO₂ without losing water and CO₂ during the extraction resulting in CO₂ gas being produced. Further, the method according to any aspect of the present invention also provides a means of storing the CO₂ in a useful form where it may be easily transported and used in the future.

According to an aspect of the present invention, there is provided a method of extracting carbon dioxide (CO₂) gas from an aqueous solution comprising dissolved CO₂, the method comprising:
(a) contacting the aqueous solution with dissolved CO₂ with an organic phase;
(b) heating the aqueous solution and the organic phase to a temperature of at least 50° C., whereby the CO₂ migrates from the aqueous solution to the organic phase; and
(c) separating the CO₂ from the organic phase,
wherein the aqueous solution comprises at least 50% water by weight at a temperature of 10° C. to and a base; the organic phase has a higher CO₂ solubility relative to water solubility; and the aqueous solution and the organic phase are in direct contact with each other and are maintained as two separate phases.

The term “contacting”, as used herein, means bringing about direct contact between the CO₂ and the aqueous solvent and/or bringing into direct contact the aqueous CO₂ (aqueous solution with dissolved CO₂) with the organic solvent. In one example, the CO₂ being in a gaseous state is brought into direct contact with the aqueous solution and added to the organic solvent according to any aspect of the present invention. In another example, the aqueous solution with dissolved CO₂ is brought into direct contact with the organic phase without mixing the two phases (i.e. aqueous and organic phase).

The term “about” as used herein refers to a variation within 20 percent. In particular, the term “about” as used herein refers to +/−20%, more in particular, +/−10%, even more in particular, +/−5% of a given measurement or value.

According to any aspect of the present invention, the organic phase may comprise a liquid carbon-based organic solvent that comprises at least one alkyl group. According to this aspect, the organic phase may be any carbon-based organic solvent, that may be capable of dissolving CO₂, especially at higher temperatures. The organic phase used in step (a) has a different solubility of CO₂ compared to the aqueous phase at different temperatures. For example, at room temperature, CO₂ may be more soluble in an aqueous solvent compared to an organic solvent. However, when the temperature is increased, to about 50° C. and above, CO₂ may be relatively more soluble in the organic solvent compared to the aqueous solution and may therefore migrate from the aqueous solvent to the organic solvent, for example in step (b) of the method according to any aspect of the present invention, where the CO₂ migrates from the aqueous phase to the organic phase.

In Table 1 of Tremper, K. K. J. Chem. Engng. Data, 1976, 21:295-9 for example, it is shown that the solubility of CO₂ drops, although very slightly, in organic solvents over the increase in temperature. For example, solubility of CO₂ was shown to drop by about 20% with an increase in temperature in hexadecane. In the present examples however, the solubility of CO₂ drops more drastically, i.e. about 50% with a slight increase in temperature. Accordingly, the organic phase used according to any aspect of the present invention may therefore be able to strip the aqueous phase of CO₂ when the liquid comprising the aqueous and organic phases in step (b) of the method according to any aspect of the present invention is heated to at least a temperature of about 50° C.

The organic phase used according to the present invention may be selected from the group consisting of alkanes, alkenes, aromatic hydrocarbons, alcohols, organic solvents containing carbon, hydrogen and oxygen, halogen compounds, nitrogen compounds, phosphorus, silicon and sulfur compounds, mineral oils, animal and vegetable oils and fats, polymeric materials, liquid gases and the like. In particular, the list of non-aqueous (i.e. organic) solvents may be selected from the solvents mentioned in Peter G. T. Fogg, Solubility Data Series, Volume 50, Carbon Dioxide in Non-Aqueous Solvents at Pressures less than 200 KPa, Pergamon Press, Oxford, New York, Seoul, Tokyo, 1992. In one example, the organic solvents that comprise at least one alkyl group may be selected from the group consisting of hydrocarbons, fluorinated hydrocarbons, esters and ethers. In particular, the organic solvent may be immiscible with the aqueous solvent. Some examples of hydrocarbons that may be used as organic solvents may be propane, butane, pentane, hexane, heptane, higher alkanes such as octadecane, squalene (and all associated isomers of these hydrocarbons) or mixtures thereof. Other organic solvents include, fluorinated solvents such as 1,1,1,2-tetrafluoroethane, iodotrifluoromethane, tetrafluoropropenes, such as 2,2,2,3-tetrafluoro-1-propene or mixtures thereof, or any other fluorinated solvent. In particular, the organic solvent may be at least one alkane. More in particular, the organic phase may comprise hexadecane.

In another example, the organic phase may comprise a solid organic polymer, e.g., polypropylene.

FIG. 2 is a schematic picture of a device for carrying out the method according to any aspect of the present invention wherein the organic phase is a solid organic polymer. The aqueous phase comprising the dissolved CO₂ passes through a tube essentially consisting of the solid organic phase, i.e. the solid organic polymer. At a temperature of at least 50° C. the CO₂ migrates from the aqueous phase to the organic phase (step (b)).

In another example as shown in FIG. 4, the method according to any aspect of the present invention is a carried out in a device wherein the organic phase is an organic solution. The aqueous phase comprising the dissolved CO₂ passes through a section present below the liquid organic phase/solution. At a temperature of at least 50° C. the CO₂ migrates from the aqueous phase to the organic phase (step (b)).

The term ‘organic phase’ may refer to an organic solid, organic solution or organic solvent that is a non-aqueous solution relative to the aqueous solution or aqueous phase according to any aspect of the present invention. The organic phase has a higher CO₂ solubility relative to water solubility. In particular, the method according to any aspect of the present invention has two phases (organic and aqueous phase) that come in contact with one another without actually mixing. The two phases are thus in contact but maintained as two separate phases. The term ‘aqueous phase’ may be used interchangeably with the term ‘aqueous solution’.

This method according to any aspect of the present invention also teaches a means of being able to desorb CO₂, avoiding water desorption into a gas phase. In particular, in this method, the varying solubility of CO₂ at higher temperatures in an aqueous solution/solvent, i.e. the aqueous phase in the method according to any aspect of the present invention, compared to the solubility of CO₂ in an organic solution/solvent, i.e. the organic phase according to any aspect of the present invention, is used to extract the CO₂ from a gas mixture. Therefore, CO₂ is desorbed from an organic phase and not an aqueous phase making the process of desorbing CO₂ more efficient and cost-effective. The solubility of water in selected organic solvents is described in J. Kirchnerova and G. C. B. Cave, Can. J. Chem. Vol 54, 3909-3916 (1976).

The aqueous phase or aqueous solution comprises any solution comprising water, at least 50% water by weight as solvent. The aqueous phase may comprise at least 70, 75, 80, 90, 95 98%, 99 or 99.9% water by weight. In one example, water may be used as the aqueous solution according to any aspect of the present invention. Aqueous phase mainly refers to a solution which comprises substantially water. The pure water is optionally a solvent consisting of pure water, such as deionized or distilled water (with no organic solvent present). Typically, the aqueous phase is free from organic solvents. However, if organic solvents are present, for example ethanol, they form part of the aqueous phase in small amounts (e.g. equal to or less than: 20%, 15%, 10%, 5%, 2% or 1% by weight) so that their presence in the final aqueous phase is negligible. Examples of aqueous solutions include water (for example, tap water, distilled water, or reverse osmosis water), acidic water, alkaline water, salt solutions (such as sodium chloride, potassium chloride, calcium chloride), polysaccharide or sugar solutions (such as guar gum), aqueous protein solutions and ethanol-water mixtures. A skilled person would understand that tap water may be used as an aqueous solution and that tap water may contain natural minerals, salts and/or other solutes, which would not affect the method according to any aspect of the present invention.

The aqueous phase according to any aspect of the present invention also comprises a base, e.g. an amine, preferably a water-soluble amine with a boiling point of at least 100° C., an inorganic hydroxide, carbonate or hydrogencarbonate salt, preferably a hydroxide, carbonate or hydrogencarbonate of an alkali metal or of an earth alkali metal. The amine should be immiscible in organic solvents and should raise the pH of water above 7 if dissolved in water, e.g. 2-aminoethanol (monoethanolamine). In particular, the base may be selected from the group consisting of an amine, a hydroxide or a mixture thereof.

During step (b) of the method according to any aspect of the present invention, i.e. heating the aqueous phase/solution and the organic phase to a temperature of at least 50° C., the partial pressure of CO₂ preferably ranges from about 1 bar to about 74 bar. In particular, the pressure in step (b) depends on the maximum temperature and corresponds to the water pressure at this temperature and the extracted CO₂ amount.

The method according to any aspect of the present invention may further comprise a step of separating the aqueous phase from the organic phase after step (b) at the same temperature as in step (b) by using known methods in the state of the art, like mechanically separating the phases (aqueous phase and organic phase) in a decanter or hydrocyclone, as the aqueous phase has higher density than the organic phase, so it can be removed mechanically. The two phases may also be separated using mixer-settlers, pulsed columns, thermal separation and the like. A skilled person may be able to select the best method of separating the two phases.

The aqueous phase separated from the organic phase may further be cooled and recycled for the method according to any aspect of the present invention.

In step (b), the organic and the aqueous phases are then heated to a temperature of at least about 50° C. At 50° C. and above, the solubility of CO₂ is different from the solubility of CO₂ at a lower temperature, for example room temperature. For example, CO₂ is more soluble in an aqueous solution at room temperature compared to at 60° C. In particular, as temperature increases, the solubility of CO₂ in an aqueous solution decreases and the relative solubility of CO₂ in an organic material, e.g. organic solvent or solid organic polymer, increases.

According to step (b), the liquid comprising both the organic and aqueous phases is then heated to a temperature of at least about 50° C. In particular, the temperature in step (b) may be 55, 60, 65, 70, 75, 80, 90, 100, 110, 120, 130, 140, 145, 150, 155, 160, 165, 170, 175, 180, 185, 190, 195 or 200° C. In one example, step (b) according to any aspect of the present invention may involve heating the temperature of the liquid to a temperature in the range of 50-200, 60-200, 70-200, 80-200, 90-200, 100-200, 50-180, 60-180, 70-180, 80-180, 90-180, 100-180, 50-150, 60-150, 70-150, 80-150, 90-150, 100-150, 50-120, 60-120, 70-120, 80-120, 90-120, 50-100, 60-100, 70-100, or 80-100° C. At this temperature, the CO₂ migrates from the aqueous phase to the organic phase.

Preferably, in step (b), the aqueous phase and the organic phase are heated to a temperature between about 50° C. and about 200° C.

In step (c), the CO₂ is separated from the organic phase using any method known in the art. In particular, the CO₂ is separated from the organic phase in step (c) under cooling the organic phase comprising CO₂ and releasing the pressure from the organic phase. The pressure in step (c) is preferably decreased to 1 bar and the organic phase is cooled down to a temperature range from about 10° C. to about 40° C. The organic phase may then be recycled to step (a).

The organic phase comprising the dissolved CO₂ of step (c) may be fed to a separate chamber, where optionally residual water is separated as a separate phase. The solubility of water in the organic solvents decreases with rising temperatures. To avoid water losses and energy losses by water evaporation, the formed second water phase should be separated before releasing the pressure. Next the overpressure is released. The released gas is mainly composed of CO₂. Therefore, a pure CO₂ gas stream is produced.

In one example, the CO₂ in the aqueous solution is first captured from a gas mixture and the flow of the gas mixture is directed through the aqueous solution to obtain the aqueous solution comprising dissolved CO₂ using according to any aspect of the present invention. The aqueous medium dissolves the CO₂. In particular, the aqueous phase that comprises at least 50% water by weight at a temperature of the aqueous phase from about 10° C. to about 40° C. whereby the CO₂ from the gas mixture dissolves in the aqueous phase. This method according to any aspect of the present invention is especially efficient as it allows for CO₂ to be absorbed readily. Usually, CO₂ is absorbed from a gas mixture using strong bases like caustics and powerful amines. CO₂ may be efficiently absorbed using these bases. The present invention also provides a means of direct capture of CO₂ from a CO₂ comprising gas. In particular, the present invention captures the CO₂ from ambient air and converts the captured CO₂ to a pure CO₂ gas stream circumventing unwanted water desorption. The method according to any aspect of the present invention further provides the advantages of reducing the CO₂ concentration in the air as well as provides a useful CO₂ stream.

The aqueous phase according to any aspect of the present invention is sensitive and strong enough to be able to dissolve a high amount of the CO₂ in the ambient gas. In particular, about 50, 60, 70, 75, 80, 90 or 95% of the CO₂ in the ambient air is dissolved in the aqueous solvent according to any aspect of the present invention.

The CO₂ comprising gas according to any aspect of the present invention may be any gas that comprises CO₂ at 0.01 to 50% by volume, 0.01 to 20% by volume, 0.01 to 10% by volume or even lesser. The CO₂ comprising gas may be air, natural gas, a methane-containing biogas from a fermentation, composting or a sewage treatment plant, a combustion off-gas, an off-gas from a calcination reaction, such as the burning of lime or the production of cement, a residual gas from a blast-furnace operation for producing iron, or a gas mixture resulting from a chemical reaction, such as, for example, a synthesis gas containing carbon monoxide and hydrogen, or a reaction gas from a steam-reforming hydrogen production process. The CO₂ comprising gas may also be ambient air. The amount of CO₂ in ambient air is usually in the range of 350 ppm-450 ppm by volume. In particular, the amount of CO₂ in ambient air is about 400 ppm.

The aqueous medium is preferably an aqueous production medium comprising at least one acetogenic cell and the aqueous production medium is contacted with hydrogen (H₂) to produce at least one organic acid and/or alcohol from the CO₂ separated from the organic phase in step (b). In particular, the organic phase is separated from the aqueous production medium and the organic acid and/or alcohol is recovered therefrom. The recovering of the organic acid and/or the alcohol may be carried out by contacting the aqueous production medium comprising the produced organic acid and/or alcohol with at least one liquid extractant. The liquid extractant ideally is an alkyl-phosphine oxide or at least one trialkylamine.

In one example, the aqueous production medium may be used to keep the cell, at least temporarily, in a metabolically active and/or viable state and comprises, if such is necessary, any additional substrates. The person skilled in the art is familiar with the preparation of numerous aqueous solutions, usually referred to as media that may be used to keep and/or culture the cells, for example LB medium in the case of E. coli, ATCC1754-Medium may be used in the case of C. ljungdahlii. It is advantageous to use as an aqueous production a minimal medium, i.e. a medium of reasonably simple composition that comprises only the minimal set of salts and nutrients indispensable for keeping the cell in a metabolically active and/or viable state, by contrast to complex mediums, to avoid dispensable contamination of the products with unwanted side products. For example, M9 medium may be used as a minimal medium. The cells are incubated with the carbon source sufficiently long enough to produce the desired product. For example, for at least 1, 2, 4, 5, 10, 30 or 20 hours. The temperature chosen must be such that the cells remains catalytically competent and/or metabolically active, for example 10 to 42° C., preferably 30 to 40° C., in particular, 32 to 38° C. in case the cell is a C. ljungdahlii cell. The aqueous production medium also includes the medium in which the acetogenic cell is cultured.

The term “acetogenic cell” as used herein refers to a microorganism which is able to perform the Wood-Ljungdahl pathway and thus is able to convert CO, CO₂ and/or hydrogen to acetate. These microorganisms include microorganisms which in their wild-type form do not have a Wood-Ljungdahl pathway, but have acquired this trait as a result of genetic modification. Such microorganisms include but are not limited to bacteria, in particular E. coli cells. These microorganisms may be also known as carboxydotrophic bacteria. Currently, 21 different genera of the acetogenic bacteria are known in the art (Drake et al., 2006), and these may also include some clostridia (Drake & Kusel, 2005). These bacteria are able to use carbon dioxide or carbon monoxide as a carbon source with hydrogen as an energy source (Wood, 1991). Further, alcohols, aldehydes, carboxylic acids as well as numerous hexoses may also be used as a carbon source (Drake et al., 2004). The reductive pathway that leads to the formation of acetate is referred to as acetyl-CoA or Wood-Ljungdahl pathway.

In particular, the acetogenic cells may be selected from the group consisting of Acetoanaerobium notera (ATCC 35199), Acetonema longum (DSM 6540), Acetobacterium carbinolicum (DSM 2925), Acetobacterium malicum (DSM 4132), Acetobacterium species no. 446 (Morinaga et aL, 1990, J. BiotechnoL, VoL 14, p. 187-194), Acetobacterium wieringae (DSM 1911), Acetobacterium woodii (DSM 1030), Alkalibaculum bacchi (DSM 22112), Archaeoglobus fulgidus (DSM 4304), Blautia producta (DSM 2950, formerly Ruminococcus productus, formerly Peptostreptococcus productus), Butyribacterium methylotrophicum (DSM 3468), Clostridium aceticum (DSM 1496), Clostridium autoethanogenum (DSM 10061, DSM 19630 and DSM 23693), Clostridium carboxidivorans (DSM 15243), Clostridium coskatii (ATCC no. PTA-10522), Clostridium drakei (ATCC BA-623), Clostridium formicoaceticum (DSM 92), Clostridium glycolicum (DSM 1288), Clostridium ljungdahlii (DSM 13528), Clostridium ljungdahlii C-01 (ATCC 55988), Clostridium ljungdahlii ERI-2 (ATCC 55380), Clostridium ljungdahlii 0-52 (ATCC 55989), Clostridium mayombei (DSM 6539), Clostridium methoxybenzovorans (DSM 12182), Clostridium ragsdalei (DSM 15248), Clostridium scatologenes (DSM 757), Clostridium species ATCC 29797 (Schmidt et aL, 1986, Chem. Eng. Commun., VoL 45, p. 61-73), Desulfotomaculum kuznetsovii (DSM 6115), Desulfotomaculum thermobezoicum subsp. thermosyntrophicum (DSM 14055), Eubacterium limosum (DSM 20543), Methanosarcina acetivorans C2A (DSM 2834), MooreIla sp. HUC22-1 (Sakai et aL, 2004, Biotechnol. Let., VoL 29, p. 1607-1612), MooreIla thermoacetica (DSM 521, formerly Clostridium thermoaceticum), MooreIla thermoautotrophica (DSM 1974), Oxobacter pfennigii (DSM 322), Sporomusa aerivorans (DSM 13326), Sporomusa ovata (DSM 2662), Sporomusa silvacetica (DSM 10669), Sporomusa sphaeroides (DSM 2875), Sporomusa termitida (DSM 4440) and Thermoanaerobacter kivui (DSM 2030, formerly Acetogenium kivui), the strains in brackets being preferred strains, commercially available in the respective depositories under the respective deposit number.

More in particular, the acetogenic cell may be selected from the Clostridium family. Even more in particular, the acetogenic cell used according to any aspect of the present invention may be selected from the group consisting of Clostridium aceticum (DSM 1496), Clostridium autoethanogenum (DSM 10061, DSM 19630 and DSM 23693), Clostridium carboxidivorans (DSM 15243), Clostridium coskatii (ATCC no. PTA-10522), Clostridium drakei (ATCC BA-623), Clostridium formicoaceticum (DSM 92), Clostridium glycolicum (DSM 1288), Clostridium ljungdahlii (DSM 13528), Clostridium ljungdahlii C-01 (ATCC 55988), Clostridium ljungdahlii ERI-2 (ATCC 55380), Clostridium ljungdahlii 0-52 (ATCC 55989), Clostridium mayombei (DSM 6539), Clostridium methoxybenzovorans (DSM 12182), Clostridium ragsdalei (DSM 15248), Clostridium 15 scatologenes (DSM 757), and Clostridium species ATCC 29797), the strains in brackets being preferred strains, commercially available in the respective depositories under the respective deposit number.

In particular, the strain ATCC BAA-624 of Clostridium carboxidivorans may be used. Even more in particular, the bacterial strain labelled “P7” and “P11” of Clostridium carboxidivorans as described for example in U.S. 2007/0275447 and U.S. 2008/0057554 may be used.

Another particularly suitable bacterium may be Clostridium ljungdahlii. In particular, strains selected from the group consisting of Clostridium ljungdahlii PETC, Clostridium ljungdahlii ER12, Clostridium ljungdahlii COL and Clostridium ljungdahlii 0-52 may be used in the conversion of synthesis gas to hexanoic acid. These strains for example are described in WO 98/00558, WO 00/68407, ATCC 49587, ATCC 55988 and ATCC 55989.

Step (c) of the method according to any aspect of the present invention, where the CO₂ is separated from the organic phase by contacting the organic phase with an aqueous medium that dissolves the CO₂, may for example take place in a fermenter comprising the at least one acetogenic cell, the aqueous production medium, a means of receiving a hydrogen stream, and a means of receiving the carbon dioxide (dissolved in the organic solvent).

In some examples, acetogenic cells capable of producing the organic acid and/or alcohol may be cultivated with any aqueous production media, substrates, conditions, and processes generally known in the art for culturing bacteria. This allows for the organic acid and/or alcohol to be produced using a biotechnological method. Depending on the microorganism that is used for organic acid and/or alcohol production, appropriate growth medium, pH, temperature, agitation rate, inoculum level, and/or aerobic, microaerobic, or anaerobic conditions are varied. A skilled person would understand the other conditions necessary to carry out the method. In particular, the conditions in the fermenter may be varied depending on the microorganisms used. The varying of the conditions to be suitable for the optimal functioning of the microorganisms is within the knowledge of a skilled person.

The pH of the aqueous production medium is in the range between 4.0 and 6.9, particularly between 5.0 and 7.0, most particularly between 5.0 and 6.5. The pressure may be between 0.9 and bar. The microorganisms may be cultured at a temperature ranging from about 20° C. to about particularly ranging from about 25° C. to about 40° C. In one example, the microorganism may be cultured at 37° C.

In some examples, for the growth of the microorganism and for its production of organic acid and/or alcohol, the aqueous production medium may comprise any nutrients, ingredients, and/or supplements suitable for growing the microorganism or for promoting the production of the organic acid and/or alcohol. In particular, the aqueous production medium may comprise at least one of the following: carbon sources, nitrogen sources, such as an ammonium salt, yeast extract, or peptone; minerals; salts; cofactors; buffering agents; vitamins; and any other components and/or extracts that may promote the growth of the bacteria. The aqueous production medium to be used must be suitable for the requirements of the particular strains. Descriptions of aqueous production media for various microorganisms are given in “Manual of Methods for General Bacteriology”.

The acetogenic cell converts the carbon dioxide in the aqueous production medium to at least one alcohol, at least one organic acid or a mixture of alcohol and organic acid. In particular, the organic acid may e.g. be acetic acid, butyric (butanoic) acid, hexanoic acid and mixture thereof. The alcohol may e.g. be ethanol, butanol, hexanol and mixtures thereof. In one example, a combination of both an alcohol and an organic acid is formed. In particular, the alcohol is ethanol and the organic acid acetic acid.

The CO₂ separated from the organic solvent now reacts with hydrogen using an acetogenic cell to form an acid and/or alcohol. Since the temperature at which the separation step (d) may be carried out is lower than step (c), the CO₂ may migrate from the organic solvent to the aqueous production medium, making the CO₂ available as a substrate for the acetogenic cell to form an organic acid and/or alcohol. In particular, an acetogenic cell like Clostridium autoethanogenum may be used to convert the liquid CO₂ from the organic solvent to at least one acid and/or alcohol like acetic acid and/or ethanol in the aqueous production medium.

The recovering of the organic acid and/or the alcohol contained in the aqueous production medium may be carried out by contacting the production medium with liquid extractant and ideally resulting in the formation of two phases.

As liquid extractant at least one alkyl-phosphine oxide or at least one trialkylamine may be used. In particular, the liquid extractant may further comprise a hydrocarbon. More in particular, the liquid extractant comprises:
at least one alkyl-phosphine oxide and at least one alkane or aromatic hydrocarbon; or
at least one trialkylamine and at least one alkane or aromatic hydrocarbon.

The liquid extractant may efficiently extract the organic acid and/or alcohol from the aqueos production medium into the liquid extractant, e.g. a mixture of alkyl-phosphine oxide or trialkylamine and at least one alkane. The liquid extractant may e.g. be a mixture of alkyl-phosphine oxide or trialkylamine and at least one aromatic hydrocarbon. Such extractant is not toxic for the acetogenic cell.

The alkane may comprise at least 12 carbon atoms. In particular, the alkane may comprise 12-18 carbon atoms. In one example, the alkane may be selected from the group consisting of dodecane, tridecane, tetradecane, pentadecane, hexadecane, heptadecane and octadecane. In a further example, the liquid extractant may comprise a mixture of alkanes. In another example, the alkane may be a branched alkane. In particular, the branched alkane may be squalene.

Alkyl-phosphine oxides have a general formula of OPX₃, where X is an alkyl. Suitable alkyl phosphine oxides according to any aspect of the present invention include an alkyl group composed of a linear, branched or cyclic hydrocarbon, the hydrocarbon composed of from 1 to about 100 carbon atoms and from 1 to about 200 hydrogen atoms. In particular, “alkyl” as used in reference to alkyl phosphine oxide according to any aspect of the present invention can refer to a hydrocarbon group having 1 to 20 carbon atoms, frequently between 4 and 15 carbon atoms, or between 6 and 12 carbon atoms, and which can be composed of straight chains, cyclics, branched chains, or mixtures of these. The alkyl phosphine oxide may have from one to three alkyl groups on each phosphorus atom. In one example, the alkyl phosphine oxide has three alkyl groups on P. In some examples, the alkyl group may comprise an oxygen atom in place of one carbon of a C₄-C₁₅ or a C₆-C₁₂ alkyl group, provided the oxygen atom is not attached to P of the alkyl phosphine oxide.

Typically, the alkyl phosphine oxide is selected from the group consisting of tri-octylphosphine oxide, hexyl-dioctylphosphine oxide, dihexyl-octylphosphine oxide, tri-butylphosphine oxide, hexyl-phosphine oxide, octylphosphine oxide and mixtures thereof. Even more in particular, the alkyl phosphine oxide may be tri-octylphosphine oxide (TOPO), hexyl-dioctylphosphine oxide, dihexyl-octylphosphine oxide and mixtures thereof.

Trialkylamines are organic-chemical compounds derived from ammonia (NH₃), whose three hydrogen atoms are replaced by alkyl radicals. Examples of trialkylamines are dimethylethylamine, methyldiethylamine, triethylamine, dimethyl-n-propylamine, dimethyl-1-propylamine, methyl-di-n-propylamine, dimethylbutylamine, trioctylamine and the like. In particular, the trialkylamine used in the liquid extractant may not be soluble in water and may be trioctylamine.

In one example, the liquid extractant may be a combination of alkyl-phosphine oxide or trialkylamine and at least one alkane. In particular, the alkane may comprise at least 12 carbon atoms. In particular, the alkane may comprise at 12-18 carbon atoms. In one example, the alkane may be selected from the group consisting of dodecane, tridecane, tetradecane, pentadecane, hexadecane, heptadecane and octadecane. In a further example, the liquid extractant may comprise a mixture of alkanes. More in particular, the liquid extractant may be a combination of TOPO and tetradecane or hexadecane. Even more in particular, the liquid extractant may be a mixture of Trioctylphosphine oxide (TOPO) and hexadecane or Tri-Alkyl Phosphine Oxide (TAPO) and hexadecane.

Trioctylphosphine oxide (TOPO) is an organophosphorus compound with the formula OP(C₈H₁₇)₃. TOPO may be part of the liquid extractant together with at least one alkane, branched alkane or aromatic hydrocarbon according to any aspect of the present invention. In particular, the mixture of TOPO and alkane, branched alkane or aromatic hydrocarbon may comprise about 1:100 to 1:10 weight ratio of TOPO relative to the alkane, branched alkane or aromatic hydrocarbon. More in particular, the weight ratio of TOPO to alkane, branched alkane or aromatic hydrocarbon in the liquid extractant according to any aspect of the present invention may be about 1:100, 1:90, 1:80, 1:70, 1:60, 1:50, 1:40, 1:30, 1:25, 1:20, 1:15, or 1:10. Even more in particular, the weight ratio of TOPO to alkane, branched alkane or aromatic hydrocarbon may be selected within the range of 1:90 to 1:10, 1:80 to 1:10, 1:70 to 1:10, 1:60 to 1:10, 1:50 to 1:10, 1:40 to 1:10, 1:30 to 1:10 or 1:20 to 1:10. The weight ratio of TOPO to alkane, branched alkane or aromatic hydrocarbon may be between 1:40 to 1:15 or 1:25 to 1:15. In one example, the weight ratio of TOPO to alkane, branched alkane or aromatic hydrocarbon may be about 1:15. In the example, the branched alkane may be squalene and the weight ratio of TOPO to squalene may be about 1:15.

In another example, when the liquid extractant comprises an alkyl-phosphine oxide or a trialkylamine that is more soluble in the alkane, branched alkane or aromatic hydrocarbon used in the liquid extractant compared to the solubility of TOPO in alkane comprising at least 12 carbon atoms, the weight ratio of the alkyl-phosphine oxide (other than TOPO) or a trialkylamine to alkane, branched alkane or aromatic hydrocarbon may be 1:1, 2:1, 3:1, 4:1, 5:1, 6:1, 7:1, 8:1, 9:1 or 10:1. In one example, the liquid extractant may be trihexy-phosphine oxide and the ratio of trihexy-phosphine oxide to alkane, branched alkane or aromatic hydrocarbon may be 1:1. In other examples, the liquid extractant may be a lower chain alkyl-phosphine oxide and the ratio of the lower chain alkyl-phosphine oxide to alkane, branched alkane or aromatic hydrocarbon may be 2:1, 3:1, 4:1, 5:1, 6:1, 7:1, 8:1, 9:1 or 10:1. In this case, a lower-chain alkyl-phosphine oxide refers to a phosphine oxide with a C₁-C₄ alkyl group. In another example, the liquid extractant may be a trialkylamine, this is known to be more soluble than phosphine oxide in alkanes, branched alkane or aromatic hydrocarbon. For example, the trialkylamine may be a trioctylamine (TOA) that may be present in the liquid extractant in the ratio of up to 1:1 with the alkane, branched alkane or aromatic hydrocarbon. Lower chain length amines can be used in even higher ratios. In other examples, the liquid extractant may be a lower chain trialkylamine and the ratio of the lower chain trialkylamine to alkane, branched alkane or aromatic hydrocarbon may be 2:1, 3:1, 4:1, 5:1, 6:1, 7:1, 8:1, 9:1 or 10:1. In this case, a lower-chain alkyl-phosphine oxide refers to a phosphine oxide with a C₁-C₄ alkyl group.

The liquid extractant alternatively may be selected from alkyl-phosphines oxides and trialkylamines, wherein the total amount of alkyl-phosphines oxides and trialkylamines referring to the total liquid extractant is at least 98.0 wt.-%, particularly at least 99.5 wt. %

The organic acid and/or alcohol in the aqueous production medium may contact the liquid extractant for a time sufficient to extract the organic acid and/or alcohol from the aqueous production medium into the liquid extractant. A skilled person may be capable of determining the amount of time needed to reach distribution equilibrium and the right bubble agglomeration that may be needed to optimize the extraction process. In some examples the time needed may be dependent on the amount of organic acid and/or alcohol that may be extracted. In particular, the time needed to extract the organic acid and/or alcohol from the aqueous production medium into the liquid extractant may only take a few minutes.

The ratio of the liquid extractant used to the amount of organic acid and/or alcohol to be extracted may vary depending on how quick the extraction is to be carried out. In one example, the amount of liquid extractant is equal to the amount of aqueous production medium comprising the organic acid and/or alcohol.

After the step of contacting the liquid extractant with the aqueous production medium, the two phases (aqueous and organic) are separated using any means known in the art. In one example, the two phases may be separated using a separation funnel. The two phases may also be separated using mixer-settlers, pulsed columns, thermal separation and the like. In one example, where the organic acid is hexanoic acid, the separation of the liquid extractant from the hexanoic acid may be carried out using distillation in view of the fact that hexanoic acid distills at a significantly lower boiling point than the liquid extractant. In another example, distillation of the products (organic acid and/or alcohol) from the very liquid extractant with a high boiling point may be used. A skilled person may be able to select the best method of separating the absorbent from the desired organic acid and/or alcohol depending on the characteristics of the organic acid and/or alcohol desired to be recovered.

In one example, the organic phase in step (a) may be the same as the liquid extractant in step (c). In this example, the organic phase and liquid extractant may be at least one alkyl-phosphine oxide or at least one trialkylamine. In particular, the organic solvent and liquid extractant may be TAPO or TOPO. In another example, the organic phase in step (b) may be TOPO or TAPO and the liquid extractant may be TAPO or TOPO in combination with an alkane, branched alkane or aromatic hydrocarbon.

The method according to present invention may comprise a further step of contacting the organic acid and/or alcohol with a second organism capable of converting the organic acid and/or alcohol to at least one fatty acid.

The second microorganism is selected from the group consisting of the bacteria is selected from the group consisting of Corynebacterium glutamicum, Halomonas boliviensis, Escherichia coli, Cupriavidus necator, Ralstonia eutropha, Clostridium kluyveri, Clostridium propionicum, Clostridium neopropionicum and Pseudomonas putida. More in particular, the second organism may be Clostridium kluyveri.

In particular, the fatty acid formed may be for example propionic acid (propanoic acid), butyric acid (butanoic acid), pentanoic acid, hexanoic acid and heptanoic acid.

According to another aspect of the present invention, there is provided an apparatus for carrying out the method according to the present invention in the case that the organic phase comprises a liquid carbon-based organic solvent that comprises at least one alkyl group and in case that the aqueous phase and the organic phase are recycled to step (b) of the method according to the present invention.

FIG. 1 is a schematic drawing of an apparatus according to the present invention:
(1) represents a first chamber, wherein the aqueous phase dissolving the CO₂ is contacted with the organic phase;
(2) is a heating device;
(3) is an inlet stream for directing the aqueous phase dissolving the CO₂ into the first chamber (1);
(4) is a second chamber;
(5) is an organic phase stream for directing the organic phase from the second chamber (4) to the first chamber (1);
(6) is an aqueous stream for directing the aqueous phase after heating and separation from the organic phase comprising CO₂ to step (a);
(7) is a cooling device;
(8) is an organic phase outlet stream;
(9) is a cooling device for cooling down the organic phase before being fed to the third chamber (10);
(10) represents a third chamber
(11) represents residual water separated from the organic phase in the third chamber (10);
(12) is an organic phase CO₂ feeding stream feeding the organic phase dissolving CO₂ to the second chamber (4),
(13) represents a pure CO₂ gas stream released from the second chamber (4).

In particular, the apparatus according to the present invention is characterized by
a first chamber (1), wherein the aqueous phase dissolving the CO₂ is contacted with the organic phase, and comprising a heating device (2) for heating the aqueous phase and the organic phase,
an inlet stream (3) for directing the aqueous phase dissolving the CO₂ into the first chamber (1),
a second chamber (4),
an organic phase stream (5) for directing the organic phase from the second chamber (4) to the first chamber (1),
an aqueous stream (6) directing the aqueous phase after heating and separation from the organic phase comprising CO₂ to step (a) and comprising a cooling device (7) for cooling down the aqueous phase before recycling to step (a),
a third chamber (10) for separating residual water (11) from the organic phase,
an organic phase outlet stream (8) comprising a cooling device (9) for cooling down the organic phase before being fed to the third chamber (10),
an organic phase CO₂ feeding stream (12) feeding the organic phase dissolving CO₂ to the second chamber (4), wherein the pressure is released, and wherein a pure CO₂ gas stream (13) from the organic phase is released and from where the organic phase is returned to the first chamber (1) through the organic phase stream (5).

The phrase “directing a flow of the CO₂ comprising gas” may refer to any means of streaming the CO₂ comprising gas into the aqueous phase of step (a) according to any aspect of the present invention. This may be in a form of an inlet, tube, valve etc.

### BRIEF DESCRIPTION OF THE FIGURES

FIG. 1 is a schematic drawing of an apparatus according to the present invention.

FIG. 2 is a schematic picture of a device for carrying out the method according to the present invention wherein the organic phase is a solid organic polymer.

FIG. 3 is the set-up used for Example 7.

FIG. 4 is a schematic picture of a device for carrying out the method according to the present invention wherein the organic phase is an organic solution/liquid organic phase.

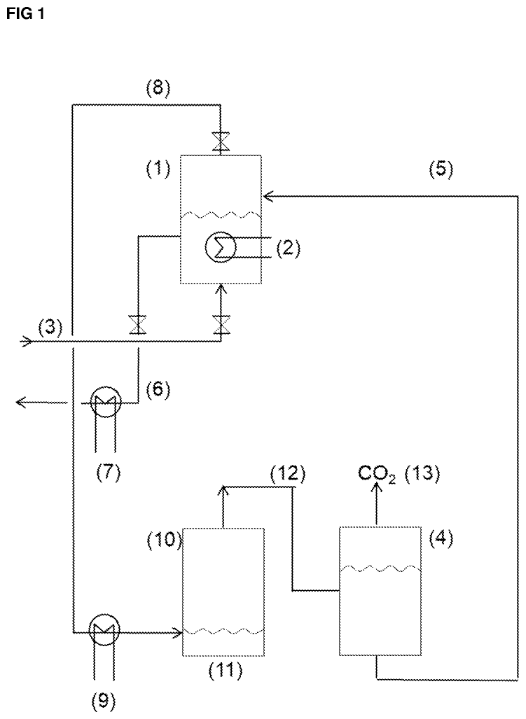

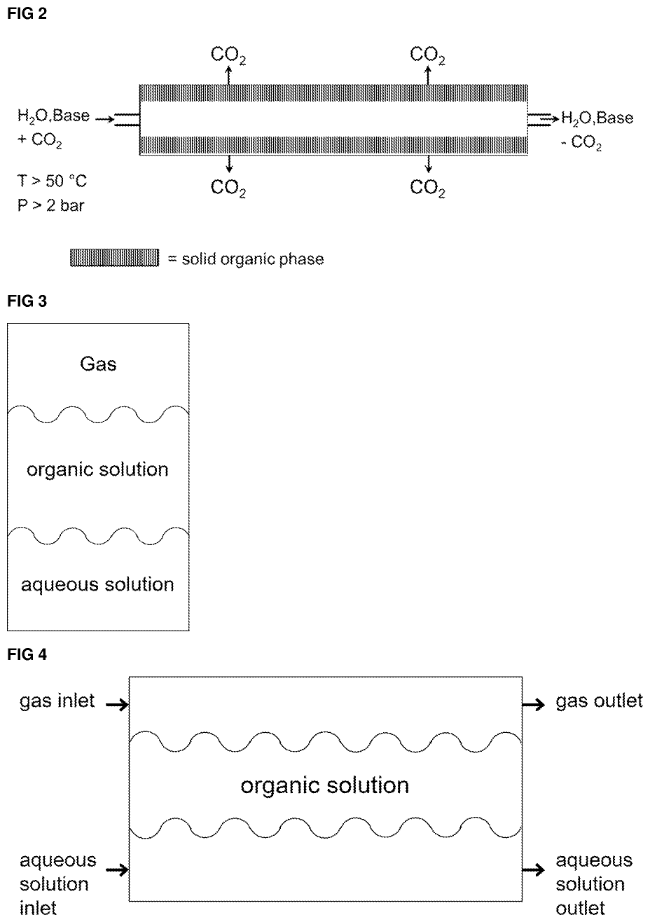

### EXAMPLES

### Example 1

An aqueous phase containing 9.9 wt. % CO₂, 63.1 wt. % H₂O and 27.1 wt. % MEA (Monoethanolamine) was mixed with hexadecane as a organic phase in a wt. ratio of 1:1 in a chamber at 30° C.

The chamber was closed and heated up to 100° C. The organic phase was analyzed by GC. It contained 0.17 wt. % CO₂ and no MEA.

The chamber was deloaded by separating half of the organic phase from the residue. The organic phase contained 0.17 wt. % CO₂.

The residue was cooled down to 30° C., mixed again with pure solvent to achieve a phase ratio of 1:1 again.

The chamber was heated up to 100° C. again. The organic phase was analyzed by GC. It contained wt. % CO₂ and no MEA.

The chamber was deloaded by separating half of the organic phase from the residue.

The solvent phase contained 0.16 wt. % CO₂.

The residue was cooled down to 30° C., mixed again with pure organic phase to achieve a phase ratio of 1:1 again.

The chamber was heated up to 100° C. again. The organic phase was analysed by GC. It contained 0.14 wt. % CO₂ and no MEA.

The chamber was deloaded by separating half of the organic phase from the residue.

The solvent phase contained 0.14 wt. % CO₂.

The residue was cooled down to 30° C., mixed again with pure organic phase to achieve a phase ratio of 1:1 again.

The chamber was heated up to 100° C. again. The organic phase was analysed by GC. It contained wt. % CO₂ and no MEA.

The chamber was deloaded by separating half of the organic phase from the residue.

The solvent phase contained 0.13 wt. % CO₂.

This example shows that CO₂ can be transferred from a scrubbing solution into an alkyl containing organic phase avoiding water losses and because of avoiding water evaporation also energy losses as described in the art.

### Example 2

Two parts of aqueous phase and one part of an organic phase consisting of 100% TAPO were kept under 1 bar 100% CO₂ atmosphere at pH=5.8 at two different temperatures of 23° C. and 50° C.

The pH was set by a mixture of ammonia and hexanoic acid. The aqueous phase thus contained ammonia and hexanoic acid. The CO₂ concentrations of both phases were measured using gas chromatography (GC). The CO₂ concentration in the aqueous phase dropped from 1.5 mg/g at 23° C. to 0.65 mg/g at 50° C. or 57%. The CO₂ concentration in the organic phase dropped from 2.5 mg/g to 1.7 mg/g or 32%. The water concentration of the organic phase dropped from 13.5 to 9.6 mg/g as the temperature increased.

This showed that the limited water absorbing alkyl containing organic solvent (TAPO) lost relatively less CO₂ solubility with rising temperatures than water. That meant that increasing the temperature transferred CO₂ from the aqueous to the organic phase. In contrast, water was transferred from the organic phase to the aqueous phase rising the temperature, because the water solubility in the organic phase dropped with rising temperatures. Therefore, no water was lost from the aqueous phase.

### Example 3

Two parts of aqueous phase and one part of an organic phase consisting of 50% TAPO and 50% hexadecane were kept under 1 bar 100% CO₂ atmosphere at pH=5.8 at two different temperatures of 23° C. and 50° C. The pH was set and maintained using a mixture of ammonia and hexanoic acid. The CO₂ concentrations of both phases were measured by GC. The CO₂ concentration of the aqueous phase dropped from 1.7 mg/g at 23° C. to 0.73 mg/g at 50° C. or 57%. The CO₂ concentration of the organic phase dropped from 3.1 mg/g to 2.1 mg/g or 32%. The water concentration of the organic phase was dropped from 5.1 to 4.4 mg/g as the temperature increased.

This showed that the limited water absorbing alkyl containing organic solvent (TAPO) with hexadecane has a higher CO₂ solubility than water at higher temperatures and a lower CO₂ solubility than water at lower temperatures.

This showed that the limited water absorbing alkyl containing organic phase (TAPO) lost relatively less CO₂ solubility with rising temperatures than water. That meant that increasing the temperature transferred CO₂ from the aqueous to the organic phase. In contrast, water was transferred from the organic phase to the aqueous phase rising the temperature, because the water solubility in the organic phase dropped with rising temperatures. Therefore, no water was lost from the aqueous solvent.

### Example 4

Two parts of aqueous phase and one part of an organic phase consisting of 6 wt. % TOPO and 94 wt. % hexadecane were kept under 1 bar 100% CO₂ atmosphere at a pH between 5.8 and 6.2 at a temperature of 37° C. The pH was set by a mixture of ammonia and hexanoic acid. The CO₂ concentrations of both phases were measured by GC. The CO₂ concentration of the aqueous phase dropped only very slightly at pH=6.2 from 1.2 mg/g to 1.1 mg/g. The CO₂ concentration of the organic phase dropped also only very slightly from 2.3 mg/g to 2.1 mg/g. The water concentration of the organic phase was 0.3 mg/g.

### Example 5

Two parts of aqueous phase and one part of an organic phase consisting of 6 wt. % TAPO and 94 wt. % hexadecane were kept under 1 bar 100% CO₂ atmosphere at a pH between 5.8 and 6.2 at a temperature of 37° C. The pH was set by a mixture of ammonia and hexanoic acid. The CO₂ concentrations of both phases were measured by GC. The CO₂ concentration of the aqueous phase dropped only very slightly at pH=6.2 from 1.3 mg/g to 1.1 mg/g. The CO₂ concentration of the organic phase was rose also only slightly from 2.5 mg/g to 2.6 mg/g. The water concentration of the organic phase was between 0.1 and 0.2 mg/g.

In Examples 3 to 5, the temperature was not varied but the pH was raised from 5.8 to 6.2. These examples show that the CO₂ solubilities in different organic solvents were very similar and are not affected by changes in pH. Again, in all cases no water was lost from the aqueous phase.

### Example 6

Two parts of aqueous phase and one part of an organic phase consisting of 100 wt. % TAPO were kept under 1 bar 100% CO₂ atmosphere at a pH between 5.8 and 6.2 at a temperature of 37° C. The pH was set by a mixture of ammonia and hexanoic acid. The CO₂ concentrations of both phases were measured by GC. The CO₂ concentration of the aqueous phase rose only very slightly at pH=6.2 from 1.0 mg/g to 1.1 mg/g. The CO₂ concentration of the organic phase dropped also only very slightly from 2.5 mg/g to 2.4 mg/g. The water concentration of the organic phase was between 8.3 and 8.5 mg/g. In this example 6, the pH was raised from 5.8 to 6.2 and the solvent was varied. Again, it was shown that the CO₂ solubilities in different organic solvents were very similar and were not affected by changes in pH and no water was lost. This confirmed that the organic solvent or solid of the organic phase itself does not have a significant influence on the effectiveness of the method of the present invention provided the organic phase has a higher CO₂ solubility relative to water solubility. In example 6, pure TAPO, which has a higher water than CO₂ solubility, is not effective to be used as an organic phase according to any aspect of the present invention. In contrast, hexadecane and mixtures of hexadecane with TAPO are suitable.

### Example 7

Desorption of CO₂ Relative to Water (Diffusion) in the Mixture of CO₂+Water+Monoethanolamine+Hexadecane

Materials and Methods

Table 1 shows the materials that were used in this example. The substances used were obtained commercially and used for the measurements without further purification. The aqueous monoethanolamine mixture was prepared gravimetrically. The mixture and hexadecane were degassed by repeated evacuation of the vapour phase in cooled storage vessels.

TABLE 1
Materials used in Example 7,

| Components | DDB-Nummer | Source | Purity*/% |
|---|---|---|---|
| Hexadecane | 516 | Aldrich | 99 |
| Monoethanolamine (MEA) | 546 | Aldrich | >99 |
| Carbon dioxide (CO₂) | 1050 | Air Liquide | 99.995 |
| Water | 174 | — | — |

*Manufacturer information

The method was carried out in a cylinder in a set-up as shown in FIG. 3 where organic solution refers to hexadecane, aqueous solution refers to MEA and CO₂ solution and gas refers to helium, CO₂ and water. The cylinder was partially filled with hexadecane heated up to 100° C. and pressurized with Helium to 20 bar. An aqueous solution mixed with 30 wt % Monoethanolamine (MEA) and 0.415 mol CO₂/mol MEA was added slowly below the hexadecane phase, avoiding mixing and gas bubbles until an equilibrium is reached. The volume ratio of the hexadecane and the aqueous phase was 5:1. In the gas phase the mol ratio of CO₂ and water was measured. After one minute the ratio was 0.905:0.095. After four minutes the ratio was 0.865:0.135. After 121 min the equilibrium was reached and the ratio 0.382:0.618. This shows that CO₂ can be extracted from an aqueous solution very effectively with only very little water loss if an organic liquid or solid layer is present through which CO₂ and water have to migrate, meaning have to be absorbed and desorbed.

1. A method of extracting carbon dioxide (CO₂) gas from an aqueous solution comprising dissolved CO₂, the method comprising:
(a) contacting the aqueous solution with dissolved CO₂ with an organic phase;
(b) heating the aqueous solution and the organic phase to a temperature of at least 50° C., whereby the CO₂ migrates from the aqueous solution to the organic phase; and
(c) separating the CO₂ from the organic phase,
wherein the aqueous solution comprises at least 50% water by weight at a temperature of C to 40° C. and a base; the organic phase has a higher CO₂ solubility relative to water solubility; and
the aqueous solution and the organic phase are in direct contact with each other and are maintained as two separate phases.

2. The method of claim 1, wherein the base is selected from the group consisting of an amine, a hydroxide or a mixture thereof.

3. The method of claim 1, wherein the organic phase comprises a liquid carbon-based organic solvent that comprises at least one alkyl group.

4. The method of claim 1, wherein the organic phase is at least one alkane.

5. The method of claim 1, wherein the CO₂ in the aqueous solution is first captured from a gas mixture and the flow of the gas mixture is directed through the aqueous solution to obtain the aqueous solution comprising dissolved CO₂.

6. The method of claim 1, further comprising separating the aqueous solution from the organic phase after step (b) at the same temperature as in step (b).

7. The method of claim 6, further comprising cooling the aqueous solution separated from the organic phase and recycling the cooled aqueous solution.

8. The method of claim 6, wherein the CO₂ is separated from the organic phase in step (c) under cooling the organic phase comprising CO₂ and releasing the pressure from the organic phase.

9. The method of claim 8, further comprising recycling the organic phase to step (a).

10. The method of claim 1 wherein the organic phase comprises a solid organic polymer.

11. The method of claim 1, wherein in step (b), the aqueous solution and the organic phase are heated to a temperature between 50° C. and 200° C.

12. The method of claim 1, wherein the CO₂ is separated from the organic phase in step (c) by contacting the organic phase with a aqueous production medium comprising at least one acetogenic cell and wherein the aqueous production medium is contacted with hydrogen (H₂) to produce at least one organic acid and/or alcohol from the CO₂ separated from the organic phase in step (c).

13. The method of claim 12, further comprising the step of contacting the organic acid and/or alcohol with a second organism capable of converting the organic acid and/or alcohol to at least one fatty acid.

14. The method of claim 12, further comprising separating the organic phase from the aqueous production medium and recovering the organic acid and/or alcohol is by contacting the aqueous production medium comprising the produced organic acid and/or alcohol with at least one liquid extractant wherein the liquid extractant is an alkyl-phosphine oxide or at least one trialkylamine.

15. An apparatus for carrying out the method according to claim 1, the apparatus comprising
a first chamber (1), wherein the aqueous phase dissolving the CO₂ is contacted with the organic phase, and comprising a heating device (2) for heating the aqueous phase and the organic phase,
an inlet stream (3) for directing the aqueous phase dissolving the CO₂ into the first chamber (1),
a second chamber (4),
an organic phase stream (5) for directing the organic phase from the second chamber (4) to the first chamber (1),
an aqueous stream (6) directing the aqueous phase after heating and separation from the organic phase comprising CO₂ to step (a) and comprising a cooling device (7) for cooling down the aqueous phase before recycling to step (a),
a third chamber (10) for separating residual water (11) from the organic phase,
an organic phase outlet stream (8) comprising a cooling device (9) for cooling down the organic phase before being fed to the third chamber (10),
an organic phase CO₂ feeding stream (12) feeding the organic phase dissolving CO₂ to the second chamber (4), wherein the pressure is released, and wherein a pure CO₂ gas stream (13) from the organic phase is released and from where the organic phase is returned to the first chamber (1) through the organic phase stream (5).
